(19) United States
(12) Patent Application Publication
(10) Pub. No.: US 2011/0064179 A1
(43) Pub. Date: Mar. 17, 2011

(54) Advanced Fusion Fuel

(75) Inventor: Curtis A. Birnbach, New Rochelle, NY (US)

(73) Assignee: Advanced Fusion Systems LLC., White Plains, NY (US)

(21) Appl. No.: 12/885,140

(22) Filed: Sep. 17, 2010

Related U.S. Application Data
(60) Provisional application No. 61/276,901, filed on Sep. 17, 2009.

(51) Int. Cl. G21G 1/10

(52) U.S. Cl. 376/191

(57) ABSTRACT

Disclosed is a novel compound used as a fuel for thermonuclear fusion reactions for power generation applications. The compound is ¹¹Boron Deuteride, which is an analogue of Boron Hydride. Also disclosed is a method of production of this compound.

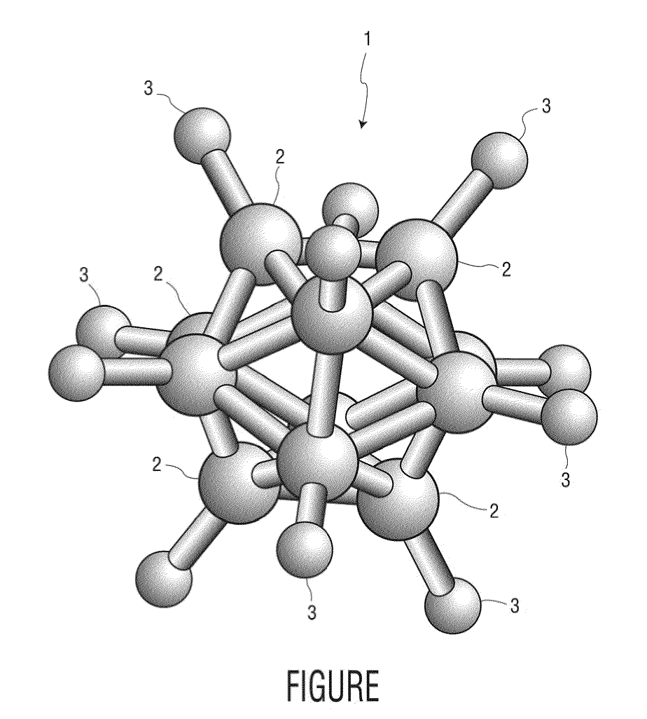

### FIELD OF THE INVENTION

The present invention relates a novel fuel for fusion power generation.

### BACKGROUND OF THE INVENTION

In chemistry, a borane is a chemical compound of boron and hydrogen. The boranes comprise a large group of compounds with the generic formulae of BₓH_{y}. These compounds do not occur in nature. There are numerous synthesized boranes known. They fall into several distinct groups. The names for the series of boranes are derived from this general scheme for the cluster geometries:
hypercloso—(from the Greek for “over cage”) a closed complete cluster, e.g., B₈Cl₈ which is a slightly distorted dodecahedron.
closo—(from the Greek for “cage”) a closed complete cluster, e.g., icosahedral B₁₂H₁₂²⁻.
nido—(from the Latin for “nest”) B occupies n vertices of an n+1 deltahedron, e.g., B₅H₉, an octahedron missing 1 vertex.
arachno—(from the Greek for “spiders web”) B occupies n vertices of an n+2 deltahedron, e.g., B₄H₁₀, an octahedron missing 2 vertices.
hypho—(from the Greek for “net”) B occupies n vertices of an n+3 deltahedron, possibly B₈H₁₆, has this structure, an octahedron missing 3 vertices.
conjuncto—2 or more of the above are fused together.

With the exception of the first two groups above, the boranes are polyhedral in shape. The exceptions, the “closo-” and “hypercloso-” forms are symmetrical and have equal numbers of boron and hydrogen atoms. However, only the hypercloso-form has a stable neutral form.

While any of the Boron Hydrides can be used in fusion reactions, the hypercloso-form as either B₁₀H₁₀ or B₁₂H₁₂ are considered to be the preferable candidates for two reasons, as follows:
Symmetry: There is strong evidence to suggest that the caged form will compress with greater symmetry than the various folded polyhedrons.
Stoichiometry: The hypercloso-forms of Boron Hydride have equal numbers of boron and hydrogen atoms. In a reaction where you are combining a proton (the ionized state of hydrogen) and a boron atom for fusion, particularly if direct conversion of the resulting charged alpha particles that result to high voltage direct current (HVDC) is considered, any surplus of electrons would have to be separated to minimize charge neutralization effects.

The combination of these two issues constitutes the reason why the hypercloso-form of boron hydride is the preferred form for use as a fusion fuel.

### BRIEF SUMMARY OF THE INVENTION

A preferred form of the present invention provides the use of an ¹¹Boron Deuteride as fuel for thermonuclear fusion reactions for power generation.

### BRIEF DESCRIPTION OF THE DRAWINGS

The sole drawing portrays a preferred fuel for thermonuclear fusion reactions.

### DETAILED DESCRIPTION OF THE PREFERRED EMBODIMENT

The current invention involves creation of an isotopologue of the foregoing Boranes by substituting deuterium for hydrogen. An isotopologue is defined by the International Union of Pure and Applied Chemistry (IUPAC) as: “A molecular entity that differs only in isotopic composition (number of isotopic substitutions), e.g. CH4, CH3D, CH2D2.” (Source: Glossary of terms used in physical organic chemistry [IUPAC Recommendations, 1994, page 1132]).

It has been demonstrated elsewhere in thermonuclear physics that isotopic substitution produces compounds which contain larger amounts of potential energy. Perhaps the most dramatic and relevant example can be found in the thermonuclear reaction of the hydrogen bomb. This device uses lithium deuteride as its fuel. It is possible to build a thermonuclear explosive with lithium hydride, which has been verified experimentally, but the energy output with the Deuteride is many times higher. Given the similarity of the inertial confinement fusion process to that of the hydrogen bomb, it is reasonable to postulate that Boron Deuteride will have similar properties in the p+¹¹B fusion reaction. The resulting reaction is now given as: D+¹¹B

Isotopologues of all the Boranes can be created using the same methods of preparation but substituting deuterated complexes for the hydrides. Additional energy output is derived in the form of additional neutrons and thermal output. Other energetic particles may be produced, depending on the specific Deuterated Borane used in the inertial confinement fusion energy-producing reaction.

It is noted that in the conventional ¹¹B₁₂H₁₂-type inertial confinement fusion reaction, the energy output is primarily carried by alpha particles. These are collected and directly converted to high voltage DC electricity by processes well known to those of ordinary skill in the art. When a Boron Deuteride is used as a fuel, two possible circumstances can occur.
In the first case, such as ¹¹B₁₂D₁₂, a mixture of alpha particles and neutrons are generated. The energy from the alpha particles is extracted as described above, while the energy carried by the neutrons is converted by conventional thermal extraction as is well known and found in all conventional fission reactors.
In the case of a boron deuteride such as ¹¹B₂₄D₁₂. A stoichiometric ratio of boron ions and deuterium ions is present and the reaction produces predominantly alpha particles. This energy may be directly converted to high voltage DC electricity by processes well known to those of ordinary skill in the art.

Methods for Deuterization of Isotopically Pure Boron: Turning now to the substitution of deuterium for hydrogen, one need only look at any chemical process where this substitution occurs. In all cases, there is an enhancement of one or more properties of the deuterized version of the compound. It is worth noting that the same situation exists for lithium in lithium-fueled fusion reactions. There, lithium deuteride would be substituted for lithium hydride with a similar resulting increase of energy output. This has been experimentally verified. These experiments have shown that the p+Li reaction yields energy at 1.7 MeV, 2.3 MeV, and a small amount of energy from a side chain reaction at 16.9 MeV. On the other hand, the D+Li reaction releases virtually all of its energy at 22.4 MeV.

Given this data, it is not unreasonable to predict that if p+¹¹B yields 3 alpha particles at 8.7 MeV, the D+¹¹B reaction should produce substantially higher output. There is also a small neutronic output of the p+¹¹B reaction at about 2.63 MeV. The deuterized fuel should produce higher energy neutrons, with energies in the vicinity of 20-28 MeV. These neutrons can be utilized in a heat-transfer reaction to produce significant amounts of thermal energy for extraction.

Manufacture of Boron Deuteride: While there are numerous routes to produce ¹¹Boron Deuteride, a preferred general process sequence includes the four process steps 1-4 as follows:

### 1. Isotope Separation

It is necessary to separate ¹¹B from ¹⁰B. ¹⁰B is a strong neutron absorber and would poison the fusion reaction. Boron has two stable isotopes: ˜80% ¹¹B and ˜20% ¹⁰B. There are several well-known processes used for this separation. Ion-exchange is the simplest isotope process to implement. Other processes include electromagnetic separation, laser, centrifugal, and thermal diffusion.

As an example, we will consider a practical ion exchange process demonstrated by Sakuma et al in 1980 (Bulletin of the Chemical Society of Japan, Vol. 53, No. 7, pp 1860-1863). Isotope separation is done by ion exchange by elution of boric acid (B(OH)₃) mixed with pure water through columns of weakly basic anion exchange resin “Dailon WA21” or equivalent

¹⁰B(OH)₃+¹¹B(OH)₄—R═¹¹B(OH)₃+¹⁰B(OH)₄—R eq. (1)

where —R represents the resin phase. The chemical form of boric acid B(OH)₃ with a pH lower than 6 is trigonal planar and that of tetrahydroxyborate (B(OH)₄) is tetrahedral with range higher than ph 11.

This process achieves enrichment from 19.84% to 91% in a simple three column exchange system. Multiple repetitions of this process will increase the enrichment level to the 99% range required. This process is simple to run and relatively non-hazardous.

Another ion exchange process exchanges between BF₃ and dimethyl ether. These examples show the diversity of methods available with this enrichment method that produce suitable end product. There are numerous other ion exchange, electromagnetic, laser, thermal and centrifugal isotope separation processes available, all of which, if carried out enough times, will result in ¹¹B isotope enrichments in excess of 99.99%, a value which is necessary for use in fusion fuels.

Typical enrichment ranges are from 1.01 to 1.04. Thermal gas-liquid exchange processes have high separation values but involve process techniques and materials that are more difficult to handle. As the resulting end product is the same from each of these processes, assuming equal isotopic enrichment levels, the choice of process is a function of the degree of difficulty and expense of a specific process.

### 2. Produce Boron from Boric Acid

Once the isotope separation stage is completed, it is necessary to produce pure boron from the boric acid. The production of boron from boric acid or borax is well-known. The traditional reaction for producing boron from boric acid is reduction by magnesium. The general reaction is:

¹¹B₂O₃+Mg→2¹¹B+3MgO eq. (2)

It is recognized that there are other reactions which will produce boron and can be successfully used in this process. A reference to this process is found at the Wolfram Research reference database topic article on boron chemistry. (scienceworld.wolfram.com/chemistry/BoronChemistry.html)

It is worth noting that boron can also be produced in commercially useful volumes from sodium fluoroborate by the electrowinning process. It can also be produced by the solvent extraction process using crown ethers.

The choice of boron production process is determined by the choice of process in the previous isotope separation process and its end product.

### 3. Purification of Boron

The boron must be purified to the highest possible levels. This is most conveniently achieved by multiple stages of float-zone refining as commonly practiced in the semiconductor industry. In this process, a section of a vertically-oriented boron ingot is heated to its melting point in a controlled atmosphere. A narrow region of the boron ingot is molten, and this molten zone is moved along the ingot by moving either the ingot or the heater. The molten region melts impure solid at its upper edge and leaves a wake of purer material solidified behind it as it moves vertically up the length of the ingot. At the end of the heating cycle, the top portion contains the bulk of the impurities and is cut off from the sample. This process is repeated a number of times until the desired purity is achieved. Purities of 99.999% or higher are readily achieved by this method. It is recognized that there are other purification methods which will accomplish the same levels of purification. This description is adapted from the reference article on zone refining on the Wikipedia website (en.wikipedia.org/wiki/Zone_refining).

### 4. Synthesis of ¹¹Boron Deuteride (¹¹B₁₂D₁₂)

The final step in this process is the preparation of the deuterated Boron product. Sodium tetradeuteroborate (Na¹¹BD₄) is compounded by the same process as sodium tetrahydroborate, a relatively common chemical, using the purified ¹¹B from the previous step and substituting deuterium for water in the reaction. A mixture of sodium tetradeuteroborate (Na¹¹BD₄), deuterodiglyme (C₆D₁₄O₃), and deuterodimethylsulfide ((CD₃)₂S) is treated with boron trifluoride deuterodiethyl etherate (¹¹BF₃.O(C₂D₅)₂) at 15 degrees C. for one hour period. A white precipitate is formed. The general equation is:

Na¹¹BD₄+C₆D₁₄O₃+((CD₃)₂S)+(¹¹BF₃.O(C₂D₅)₂)=(¹¹B₁₂D₁₂)+CD₃CD₂-O—CD₂CD₃+((CD₃)₂S)+Na¹¹BF₄ eq. (3)

The reaction mixture is then heated for 2 hours at 100 degrees C. and then for 3 hours at 150 degrees C. resulting in the formation of ¹¹B₁₂D₁₂²⁻. During the reaction, evolution of gas will occur which must be safely vented off. The remaining liquid is a mixture of deuterodimethylsulfate ((CD₃)₂S) and deuterodiethyl ether (CD₃CD₂-O—CD₂CD₃). The solid product is then dissolved in ethanol (C₂H₆O) and the insoluble sodium tetrafluoroborate (Na¹¹BF₄) is filtered off. This can be reprocessed to recover the ¹¹B.

The ethanol is then distilled out and solid residue is re-dissolved in water. This aqueous solution is then treated with triethylammonium chloride (C₆H₁₆ClN) and ¹¹B₁₂D₁₂ is obtained with ˜87% yield.

¹¹B₁₂D₁₂²⁻+(CD₃)₂S+C₆H₁₆ClN+H₂O═¹¹B₁₂D₁₂+byproducts eq. (4)

This series of reactions must be carried out in a glove box filled with inert gas (argon) for safety and purity control. This synthesis is derived from work first reported in Knoth, W. H, et al, “Derivative chemistry of B₁₀H₁₀ and B₁₂H₁₂” Journal of the American Chemical Society (1962), 84 1056-7. This work is also described in U.S. Pat. Nos. 3,265,737; 3,169,045; and 3,328,134 which disclose preparations of B₁₂H₁₂²⁻ using methods similar to those described here.

The foregoing method beneficially produces ¹¹Boron Deuteride in a preferred form of ¹¹B₁₂D₁₂, a symmetrical molecule, as shown at reference number 1 in the drawing. In the drawing, 2 represents boron atoms, and 3 represents hydrogen atoms.

What can be drawn from the preceding discussion is that there is a general methodology for production of Deuterized Boron compounds. This consists of the steps of:
Isotope Separation
Production of Boron
Purification of Boron
Deuterization of Boron

At each step, there are many possible methods that can be applied which will produce a suitable end-product for the subsequent process steps. The choice of which specific process to use at any given step is determined by a number of factors including but not limited to:
Availability of Equipment
Safety Considerations
Purity of End Product
Cost
Time

Once the specific ¹¹Boron Deuteride is synthesized, it may then be prepared into a form that is specific to the fusion process that it will be used in.

It will be obvious to one skilled in the art that there are many possible variations in the production of ¹¹Boron Deuterides that will lead to compounds as described herein.

While the invention has been described with respect to specific embodiments by way of illustration, many modifications and changes will occur to those skilled in the art. It is, therefore, to be understood that the appended claims are intended to cover all such modifications and changes as fall within the true scope and spirit of the invention.

1. The use of an ¹¹Boron Deuteride as fuel for thermonuclear fusion reactions for power generation.

2. The invention of claim 1, wherein the power output is conveyed by alpha particles and neutrons.

3. The invention of claim 1, wherein the ¹¹Boron Deuteride is ¹¹B₁₂D₁₂.

4. The invention of claim 1, wherein the ¹¹Boron Deuteride is ¹¹B₁₀D₁₀

5. The invention of claim 1, wherein the ¹¹Boron Deuteride is ¹¹B₆D₆.

6. The invention of claim 1, wherein the power output is primarily conveyed by alpha particles.

7. The invention of claim 6, wherein the ¹¹Boron Deuteride is ¹¹B₂₄D₁₂.

8. The invention of claim 6, wherein the ¹¹Boron Deuteride is ¹¹B₂₀D₁₀.

9. The invention of claim 6, wherein the ¹¹Boron Deuteride is ¹¹B₁₂D₆.
